(19) United States
(12) Patent Application Publication
(10) Pub. No.: US 2014/0226489 A1
(43) Pub. Date: Aug. 14, 2014

(54) WIRELESS TERMINAL DEVICE HAVING NETWORK LOAD REDUCING FUNCTION, METHOD FOR REDUCING NETWORK LOAD THEREOF, AND RECORDING MEDIUM THEREOF

(71) Applicant: IDEAWARE INC., Seongnam-si, Gyeonggi-do (KR)

(72) Inventor: Yang Meong Cha, Seongnam-si (KR)

(73) Assignee: IDEAWARE INC., Seongnam-si, Gyeonggi-do (KR)

(21) Appl. No.: 14/347,563

(22) PCT Filed: Feb. 12, 2013
(86) PCT No.: PCT/KR2013/001055

§ 371 Date: Mar. 26, 2014

(30) Foreign Application Priority Data
Feb. 13, 2012 (KR) 10-2012-0014422

(51) Int. Cl. H04L 12/803

(52) U.S. Cl. CPC H04L 47/125
USPC 370/236

(57) ABSTRACT

The present invention relates to a wireless terminal device having network load reducing function, a method for reducing network load thereof, and a recording medium thereof. The wireless terminal device having network load reducing function, according to the present invention, includes: a policy storage unit for receiving policy information, wherein the policy information including at least one of policy applicable target application information and network usage control policy information for each of the policy applicable target applications, and storing the policy information into a storage section; a policy checking unit for performing a first checking of at least one of the policy information stored in the storage section, and in a result of the first checking, in case there exists any of the policy information, performing a second checking of the policy applicable target application information included in the policy information, and performing a third checking of whether the policy applicable target application corresponding to a result of the second checking is included in the wireless terminal device; and a process unit, in a result of the third checking, in case the policy applicable target application is included in the wireless terminal device, by applying the network usage control policy information stored in the storage section to the policy applicable target application, for controlling network usage environment corresponding to the policy applicable target application.

### BACKGROUND OF THE INVENTION

1. Technical Field

The present invention relates to reducing network load of wireless terminal device by controlling network usage environment for each of applications included in the wireless terminal device, using network usage control policy information of the applications.

2. Description of the Related Art

After smart phones are introduced to the public, using patterns of terminal devices by individual users are rapidly moving from voice-call-oriented use to data-communication-oriented use.

As mobile (wireless) data traffic indexes in FIG. 1 show, mobile traffic is expected to continuously increase up to 26 times for the next 10 to 15 years. In the year 2010, an individual user daily used around 15 MB of mobile data, which may reach 1 GB in the year 2020.

Such increase in mobile traffic directly affects profitability and service quality of mobile carriers, forcing them to install additional equipment, consequently reducing their profits. Service dissatisfactions of mobile network users are also increasing, because of slowed speed of data communication.

Accordingly, in order to reduce investment burden and to ensure service quality, the mobile carriers are facing a challenge to make more efficient use of network infra, and need alternatives which provide predictability and real-time controllability, overcoming the limitations of conventional technology.

Meanwhile, as FIG. 2 shows, mobile network congestions are mainly caused by unnecessary use of network by the applications installed in wireless terminal devices, numerous wireless terminal devices concentrated in a limited space (e.g. stadium, subway, etc.), and using patterns of users.

In conclusion, in order to solve out both the mobile carriers' enormous waste of cost and the individual users' service dissatisfaction, alternatives capable of controlling the network using patterns have become absolutely needed. But unfortunately, solutions for these problems have not been introduced so far.

The above-mentioned problems in conventional technology and the awareness on the challenge are not obviously known for the persons who skilled in the art of the present invention. Therefore, the present invention shall not be deemed to be obvious based on this awareness.

### SUMMARY OF THE INVENTION

An object of the present invention for solving the above-mentioned problems is providing a method, a system and a recording medium for receiving policy information—the policy information including at least one of policy applicable target application information and network usage control policy information for each of the policy applicable target applications—for reducing network load, and then controlling network usage environment of the policy applicable target applications corresponding to the received network usage control policy information for each of the applications, and eventually enabling an optimized usage control of network directly at the wireless terminal device side using the policy information. With this, the mobile carriers may be able to reduce the installation cost of additional equipment and improve the service quality. At the same time, the user's data communication environment may be also improved by resolving the network congestions, with reduced consumption of batteries. In addition, the application developers and mobile carriers may operate reasonable discussion channels for each other.

Technical tasks to achieve in the present invention are not limited to the above-mentioned technical tasks. Other technical tasks which are not mentioned may be clearly understandable for those who skilled in the art of the present invention from the following description.

A wireless terminal device having function for reducing network load, according to an embodiment of the present invention, includes: a policy storage unit for receiving policy information for reducing network load from a server over a communication network, wherein the policy information including at least one of policy applicable target application information and network usage control policy information for each of policy applicable target applications, and storing the policy information into a storage section; a policy checking unit for performing a first checking of the policy information stored in the storage section, and in case there exists the policy information as a result of the first checking, performing a second checking of the policy applicable target application information included in the policy information, and performing a third checking of whether the policy applicable target application corresponding to a result of the second checking is included in the wireless terminal device; and a process unit, in case the policy applicable target application is included in the wireless terminal device as a result of the third checking, for controlling network usage environment corresponding to the application for reducing network load by applying the network usage control policy information stored in the storage section to the application.

According to an aspect of the present invention, the wireless terminal device having function for reducing network load may further include an upgrade unit for periodically upgrading the policy information stored in the storage section.

According to another aspect of the present invention, the policy checking unit, in case there exists none of the policy information as a result of the first checking, may send a request for the policy information to a server over the communication network.

According to another aspect of the present invention, the network usage control policy information may include at least one of: policy information for adjusting number of connections to a certain IP or Port or URL per hour; policy information for adjusting number of pollings requesting data to a certain IP or Port or URL; policy information for adjusting number of pushes transmitting data to a certain IP or Port or URL or ID; policy information for adjusting size or capacity of data transmitted to a certain IP or Port or URL or ID; policy information for blocking request and reception of user unauthorized target data including commercial data; policy information, in case a limit allocated to the wireless terminal device unit is exceeded, for blocking connection of data communication; and policy information, in case a communication network overload is set in a region where the wireless terminal device is located, for blocking connection of data communication.

According to another aspect of the present invention, the process unit, in case the network usage control policy information is policy information for adjusting number of connections to a certain IP or Port or URL per hour, may control number of connections to a certain IP or Port or URL per hour for the policy applicable target application,

in case the network usage control policy information is policy information for adjusting number of pollings requesting data to a certain IP or Port or URL, may control number of pollings requesting data to a certain IP or Port or URL of the policy applicable target application,

in case the network usage control policy information is policy information for adjusting number of pushes transmitting data to a certain IP or Port or URL or ID, may control number of pushes transmitting data to a certain IP or Port or URL or ID for the policy applicable target application,

in case the network usage control policy information is policy information for adjusting size or capacity of data transmitted to a certain IP or Port or URL or ID, after checking size or capacity of data transmitted through policy applicable target application, may block transmission of data exceeding a limit of size or capacity for the policy applicable target application,

in case the network usage control policy information is policy information for blocking request and reception of user unauthorized target data including commercial data, may block request or reception of user unauthorized target data of policy applicable target data,

in case the network usage control policy information is policy information, in case a limit allocated to the wireless terminal device is exceeded, may block connection of data communication, blocking connection of data communication of policy applicable target application,

in case the network usage control policy information is policy information, in case a communication network overload is set in a region where the wireless terminal device is located, for blocking connection of data communication, may block connection of data communication of policy applicable target application.

According to another aspect of the present invention, the network usage environment may include at least one of: number of network connections; network connection time; number of data transmissions; number of data receptions; data transmission capacity; data reception capacity; data transmission time; data reception time; IP or Port or URL of a connection target network; IP or Port or URL of a connection blocking target network; data communication limit; and network loading amount.

According to another aspect of the present invention, at least one of the storage unit, the policy checking unit, and the process unit may be configured with a program or program set or application. Additionally, the wireless terminal device may include at least one

of smartphone, mobile phone, and tablet PC.

A method for reducing network load in a wireless terminal device, according to an embodiment of the present invention, includes: receiving policy information for reducing network load from a server over a communication network, wherein the policy information including at least one of policy applicable target application information and network usage control policy information for each of policy applicable target applications, and storing the policy information into a storage section; checking the policy applicable target application information included in the policy information stored in the storage section; and in case the policy applicable target application is included in the wireless terminal device as a result of the checking, controlling network usage environment for the application by applying the network usage control policy information stored in the storage section to the application.

According to an aspect of the present invention, by directly controlling network usage environment of each application at the wireless terminal device side using network usage control policy information for each of the applications, it may be possible to block or control unnecessary executions of applications which may cause network load by the policy. With this, it may also be possible to use the network optimally at the wireless terminal device side.

According to another aspect of the present invention, by optimizing network usage, the mobile carriers may be able to minimalize the installation cost of additional equipment.

According to another aspect of the present invention, by optimizing network usage, it may be possible to minimalize wireless terminal device user's dissatisfaction caused by data communication delay, etc. Additionally, battery consumption of the wireless terminal device may be reduced dramatically.

According to another aspect of the present invention, through network usage pattern information for each of the applications, application developers and mobile carriers may discuss easily in order to reduce network load.

### BRIEF DESCRIPTION OF THE DRAWINGS

FIG. 1 shows a view illustrating a mobile (wireless) data traffic indexes.

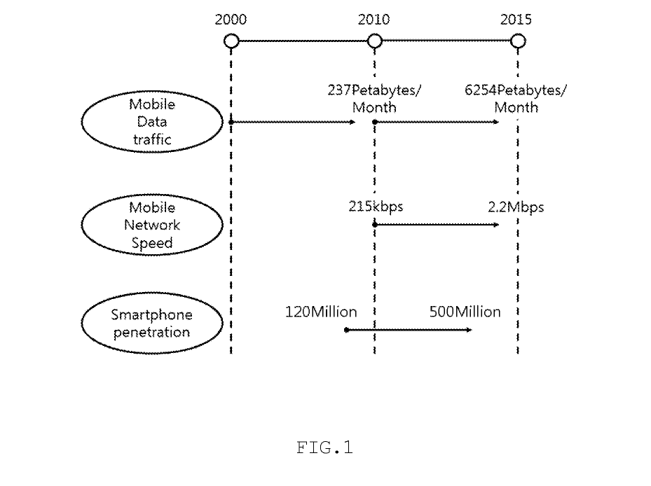

FIG. 2 shows a view illustrating main factors causing network congestions of the conventional technology.

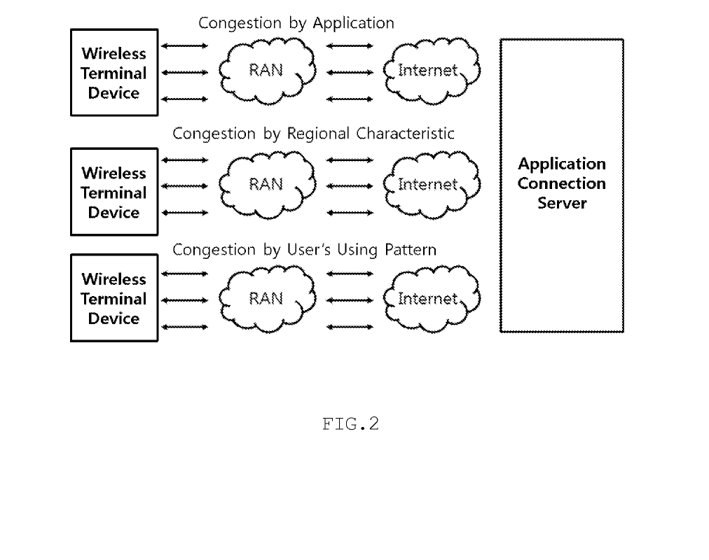

FIG. 3 shows a view illustrating communication network connection according to an embodiment of the present invention.

FIG. 4 shows a view illustrating detailed structure of a wireless terminal device according to an embodiment of the present invention.

FIG. 5 shows a view illustrating examples of applying policy information for each application according to an embodiment of the present invention.

FIG. 6 shows a view illustrating an effect of controlling network usage through policy information according to an embodiment of the present invention.

FIG. 7 shows a flow chart illustrating a process of applying policy information for a wireless terminal device according to an embodiment of the present invention.

### DESCRIPTION OF THE PREFERRED EMBODIMENTS

Hereinafter, referring to enclosed figures and descriptions, operation principles of preferred embodiments of the present invention will be described. However, figures illustrated and descriptions mentioned in the below are only for the preferred embodiments among various method of describing features of the present invention. Therefore, the present invention is not limited to the figures illustrated and descriptions mentioned in the below. Additionally, in case of determining that a detailed description about known function or structure relating to the present invention may evade the main point of the present invention, the detailed description may be omitted. Also, terms to be mentioned in the following are defined in consideration of functions in the present invention, which may be vary according to the intention of a user or an operator, practical customs, etc. Therefore, the definition of the terms shall be made based on the overall contents of the present invention.

In conclusion, the technical spirit of the present invention shall be decided by claims. The following embodiments are merely a means for describing progressive spirit of the present invention to persons who skilled in the art of the present invention.

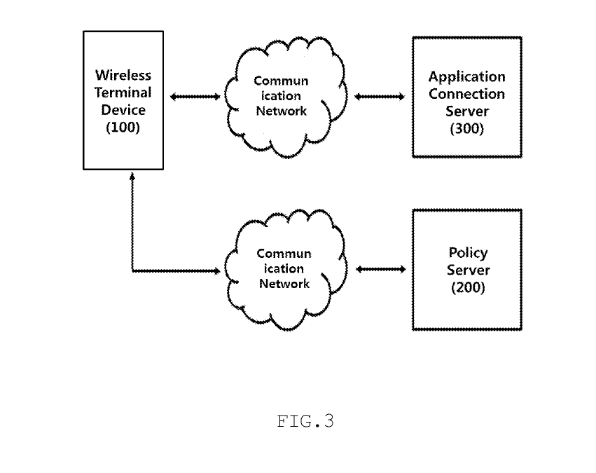

FIG. 3 shows a view illustrating a communication network or network connection according to an embodiment of the present invention.

More particularly, FIG. 3 is illustrating a structure in which a wireless terminal device 100 having a function for reducing network load is connected with a policy server 200 over communication network. The wireless terminal device 100 may receive policy information—the policy information including at least one of policy applicable target application information and network usage control policy information for each of policy applicable target applications—from the policy server 200, and may control network usage environment for each of the applications for reducing network load.

According to an embodiment of the present invention, the wireless terminal device 100, the policy server 200, and the application connection servers 300 may configure various structures according to the network connection methods over the communication network.

According to an embodiment of the present invention, the wireless terminal device 100 having function for reducing network load may receive policy information—the policy information including at least one of policy applicable target application information and network usage control policy information for each of the policy applicable target applications—for reducing network load from the policy server 200, and store the policy information into a storage section 140. The wireless terminal device 100 then may check the policy applicable target application information included in the policy information stored in the storage section 140, and in a result of the checking, in case the policy applicable target application exists in the wireless terminal device 100, by applying the network usage control policy information for the application to the application, may perform a role of controlling network usage environment.

According to an embodiment of the present invention, the network usage environment for the application may include least one of number of network connections, network connection time; number of data transmissions, number of data receptions; data transmission capacity, data reception capacity, data transmission time, data reception time; IP or Port or URL of a connection target network, IP or Port or URL of a connection blocking target network, data communication limit and network loading amount.

In addition, the wireless terminal device 100 according to the present invention may further perform a role of transmitting the network usage information of one or more policy applicable target applications included in the wireless terminal device 100 to the policy server 200 or to a server over the communication network.

According to an embodiment of the present invention, the wireless terminal device 100 may include all kinds of terminal devices which enable data communication through network, such as smart phones, mobile phones, tablet PCs, telematics, etc.

The policy server 200 according to the present invention, by using network usage pattern information of the policy applicable target application, may perform a role of generating network usage control policy information for the policy applicable target application. And then the policy server 200 may perform a role of transmitting the policy information for reducing network load—the policy information may include the generated network usage control policy information and the policy applicable target application information—to the application for reducing network load included in the wireless terminal device 100.

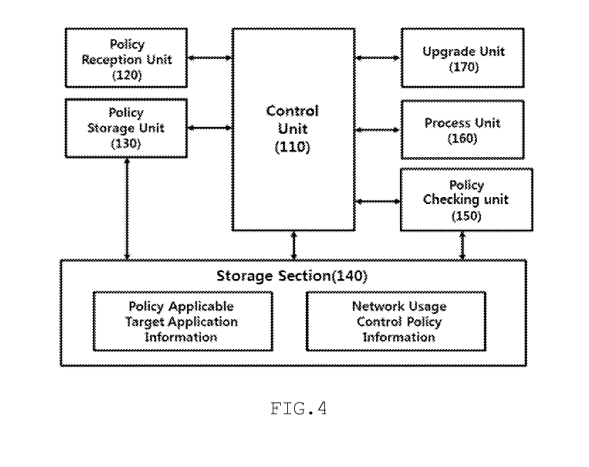

FIG. 4 shows a view illustrating detailed structure of the wireless terminal device 100 according to an embodiment of the present invention.

More particularly, FIG. 4 shows a detailed structure of the wireless terminal device 100 over the communication network as shown in FIG. 3. Each component of the structure is merely for describing embodiments of the present invention. The technical feature of the present invention is not limited to the embodiments shown in FIG. 4.

Referring to FIG. 4, the wireless terminal device 100 according to the present invention, may include a policy reception unit 120, a policy storage unit 130, a storage section 140, a policy checking unit 150, a process unit 160, an upgrade unit 170, and a control unit 110 which may control each of the components described above.

Referring to FIG. 4, the policy reception unit 120 may receive policy information—the policy information including at least one of policy applicable target application information and network usage control policy information for each of the policy applicable target applications—for reducing network load from the policy server 200. The policy storage unit 130 may store the policy information received by the reception unit 120 into the storage section 140.

The policy reception unit 120 and the policy storage unit 130 according to the present invention may renew or upgrade the policy information stored in the storage section 140 whenever changed or new information for the policy information stored in the storage section 140 is transmitted.

The storage section 140 according to the present invention may perform a role of classifying the policy information stored by the storage unit 130 into the policy applicable target application information and the network usage control policy information for each of the applications, and interconnecting and storing them. A memory included in the wireless terminal device 100 or a section allocated for the application for reducing network load or an IC chip or an USIM chip may be used for the storage section 140.

The policy checking unit 150 according to the present invention may check firstly at least one of the policy information stored in the storage section 140, and in case there exists any of the policy information as a result of the first checking, may check secondly the policy applicable target application information included in the policy information. And the policy checking unit 150 may check thirdly whether the policy applicable target application corresponding to a result of the second checking is included in the wireless terminal device 100.

According to an embodiment of the present invention, the policy checking unit 150, by matching unique code or title corresponding to the policy applicable target application information, may check whether the policy applicable target application is included in the wireless terminal device 100.

In addition, the policy checking unit 150, in case there exists none of the policy information as a result of the first checking, may further perform a role of requesting for the policy information to a server over the communication network.

The process unit 160 according to an embodiment of the present invention, in case the policy applicable target application is included in the wireless terminal device 100 as a result of the third checking by the policy checking unit 150, by applying the network usage control policy information stored in the storage section 140 to the application, may perform a role of controlling network usage environment corresponding to the application for reducing network load.

In other words, the process unit 160, in case the network usage control policy information is policy information for adjusting number of connections to a certain IP or Port or URL per hour, may control number of connections to a certain IP or Port or URL per hour,

in case the network usage control policy information is policy information for adjusting number of pollings requesting data to a certain IP or Port or URL, may control number of pollings requesting data to a certain IP or Port or URL,

in case the network usage control policy information is policy information for adjusting number of pushes transmitting data to a certain IP or Port or URL or ID, may control number of pushes transmitting data to a certain IP or Port or URL or ID,

in case the network usage control policy information is policy information for adjusting size or capacity of data transmitted to a certain IP or Port or URL or ID, after checking size or capacity of data transmitted through policy applicable target application, may block transmission of data exceeding a limit of size or capacity,

in case the network usage control policy information is policy information for blocking request and reception of user unauthorized target data including commercial data, may block request or reception of user unauthorized target data for the policy applicable target application,

in case the network usage control policy information is policy information for blocking connection of data communication when a limit allocated to the wireless terminal device 100 is exceeded, may block connection of data communication for the policy applicable target application,

in case the network usage control policy information is policy information for blocking connection of data communication when a communication network overload is set in a region where the wireless terminal device 100 is located, may block connection of data communication for the policy applicable target application.

According to an aspect of the present invention, the process unit 160 may control different network usage environment according to the type or the form of the policy information. An example of applying the network usage control policy information by the process unit 160 will be described in the following.

For example, in case the network usage control policy information for the policy applicable target application is:

<?xml version “1.0” encoding=“UTF-8”?>
<policy>
<description> Rules for block app </description>
<rule>
<rule_id> T_2012_B_02_103030_P2 </rule_id>
<rule_act> B_03_P_01 </rule_act>
<app_id> T_2012_A_08_2089_K2_09_3092 </app_id>
<target_ip> 192.168.0.255 </target_ip>
<port> 80 </port>
<refresh> 30 sec </refresh>
</rule>
<sign>e5c6e5ccec361baebcf79859e49c5526</sign>
</policy>

In this case, among the above policy information, “<rule_id> T_{—}2012_B_{—}02_{—}103030_P2 </rule_id>” defines the policy value, which indicates that the policy is application network blocking policy (B02)in the year 2012, and the policy administrator's authority is 103030, and the priority for applying the policy is P2 level.

Here, “<rule_id> T_{—}2012_B_{—}02_{—}103030_P2 </rule_id>” may be replaced by “<rule_id> T_{—}2012_P_{—}02_{—103030}_P2 </rule_id>” used for application network polling policy (P02) in the year 2012, or may be used for application network loopback policy (L05) in the year 2012, or may be replaced by “<rule_id> T_{—}2012_L_{—}05_{—}103030_P3 </rule_id>” which indicates that the policy administrator's authority is 103030 and the priority for applying the policy is P3 level.

In addition, “<rule_act> B_{—}03_P_{—}01 </rule_act>” is indicating that the performing method for applying the policy is “apply immediately”.

And, “<app_id> T_{—}2012_A_{—}08_{—}2089_K2_{—}09_{—}3092 </app_id>” means that the policy applicable application ID is from “A_{—}08_{—}2089_K2” to “09_{—}3092” and a mask value of the policy applicable application is K2.

And, “<sign>e5c6e5ccec361baebcf79859e49c5526</sign>” is a value for integrity verification of the policy information in order to check if the policy document is tampered while coming through the network. “<target_ip> 192.168.0.255 </target_ip>”, and “<port> 80 </port>” indicate that the target IP address for blocking (functions such as loopback) is 192.168.0.255, and the target port is 80, respectively.

In addition, “<refresh> 30 sec </refresh>” means that refresh timeout is set to 30 sec. In this case, proxy/cache server will be used for the corresponding packet, and at this time, it means that the request packet transmitted from the wireless terminal device 100 to the network will be forwarded to the proxy/cache server every 30 seconds.

In this case, for transmitting the packet from user's wireless terminal device 100, methods such as forwarding, registering the corresponding bypass information in DNS server, or dynamically/statically changing a routing table for the certain IP address may be used. Unconditional forwarding (bypass) method using the wireless terminal device 100 of user may be used for blacklisting policy for chronic malignant service/packet.

In case the policy information has the definition as above, the process unit 160 according to the present invention, in order to control network usage environment for the application, may recognize that the policy is application network blocking policy in the year 2012 based on “<rule_id> T_{—}2012_B_{—}02_{—}103030_P2 </rule_id>”, and may recognize that the method for applying the policy is “apply immediately” based on “<rule_act> B_{—}03_P_{—}01 </rule_act>”, and may recognize that the policy applicable application ID is from “A_{—}08_{—}2089_K2” to “09_{—}3092” and the policy applicable application mask value is K2 based on “<app_id> T_{—}2012_A_{—}08_{—}2089_K2_{—}09_{—}3092 </app_id>”, and may check if the policy document is tampered through the network based on “<sign>e5c6e5ccec361baebcf79859e49c5526</sign>”, and may recognize that the target IP address for blocking (functions such as loopback) is 192.168.0.255, and the target port is 80 based on “<target_ip> 192.168.0.255 </target_ip>” and “<port> 80 </port>”, and may set refresh timeout as 30 sec based on “<refresh> 30 sec </refresh>”.

The above example of processing by the process unit 160 is merely an embodiment. The process may be various according to characteristics or type of the policy.

The upgrade unit 170 according to an embodiment of the present invention, in case the network usage control policy information for the policy applicable target application is changed, may process upgrading of the network usage control policy information stored in the storage section 140, for the policy applicable target application.

According to an embodiment of the present invention, a whole or a part of the functions of each component included in the policy server 200 may be implemented in a program or program set.

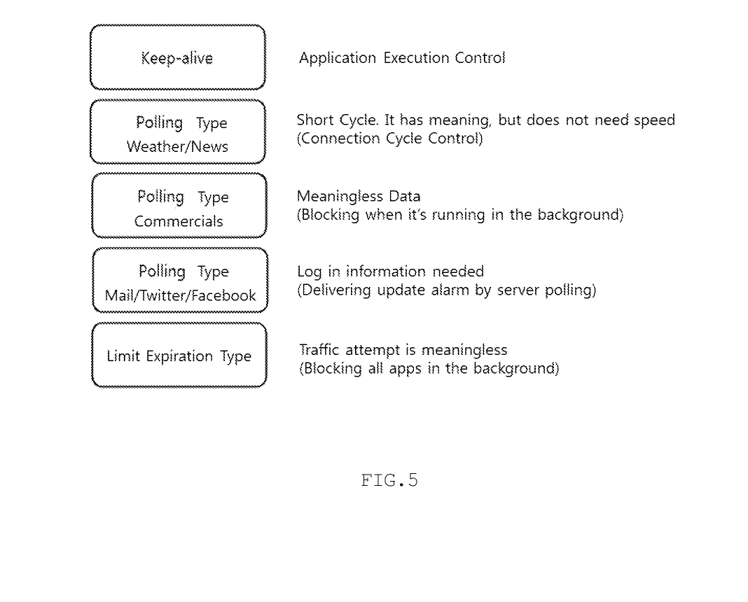

FIG. 5 shows a view illustrating examples of applying policy information for each application according to an embodiment of the present invention.

Referring to FIG. 5, in case the policy applicable target application is an application which maintains a state of Keep-Alive, the network usage control policy information is set for controlling execution itself of the application in order to control execution of the application. In case the policy applicable target application is an application which executes frequent pollings, the network usage control policy information is set for controlling the number of pollings or the period of pollings in order to adjust the number of pollings or the period of pollings. In case available data limit of the wireless terminal device 100 is expired, the traffic attempt is regarded as meaningless, thus the network usage control policy information is set for blocking network connection of every applications in background in order to control blocking network usage of each application.

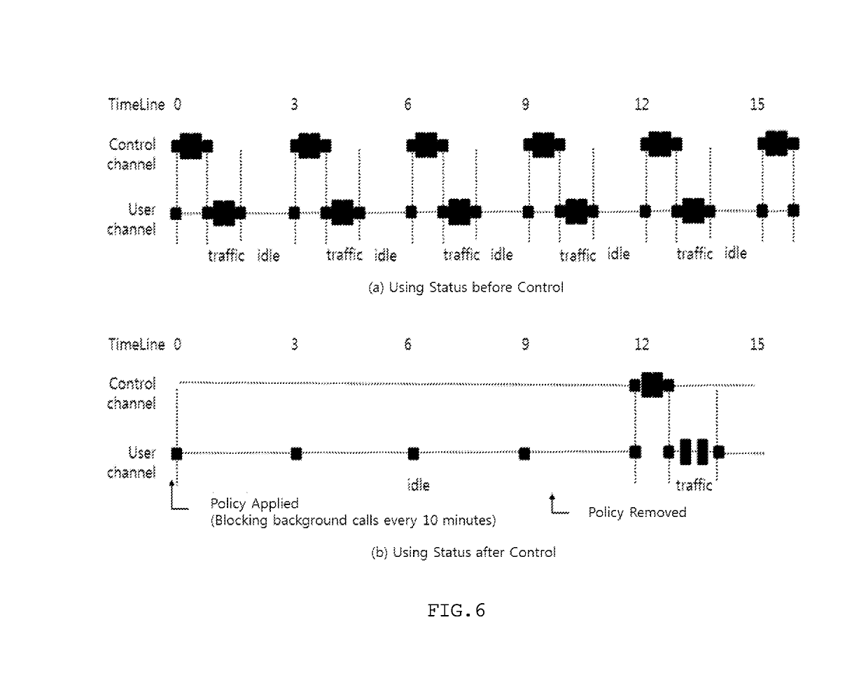

FIG. 6 shows a view illustrating an effect of controlling network usage using policy information according to an embodiment of the present invention.

Referring to FIG. 6, in response to the network usage control using the network usage control policy information (policy for blocking background call admission every 10 minutes) by the network load reduction application included in the wireless terminal device 100, the effect of traffic reduction in the wireless terminal device 100 before and after network usage environment control by applying the policy is shown.

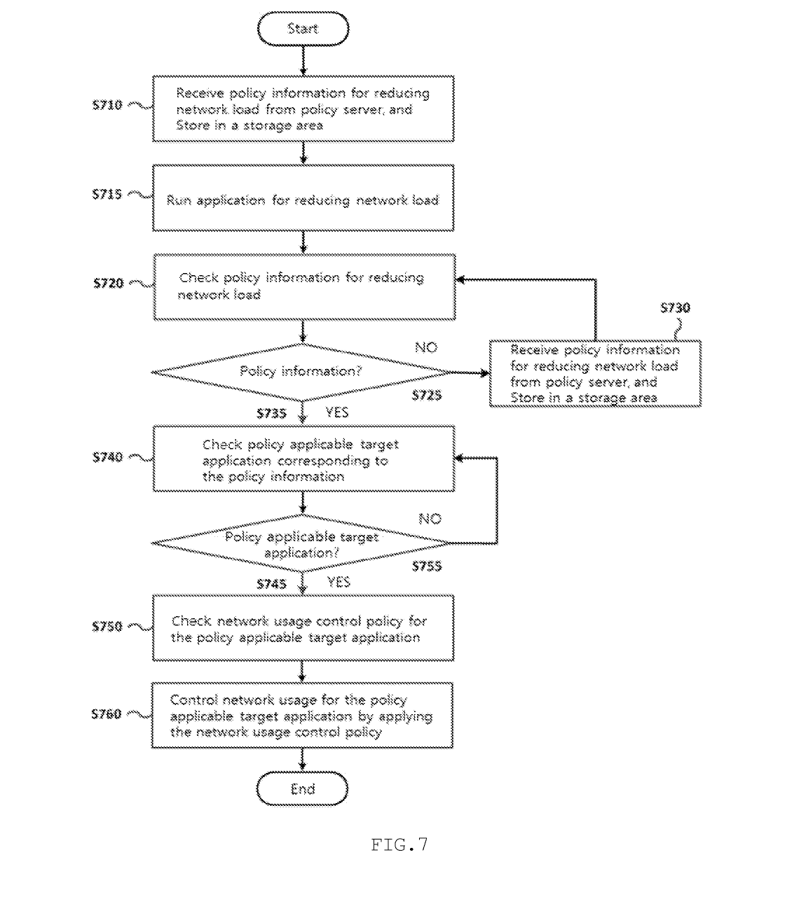

FIG. 7 shows a flow chart illustrating a process of applying policy information for the wireless terminal device 100 according to an embodiment of the present invention.

At first, the wireless terminal device 100 may receive the policy information for reducing network load—the policy information including at least one of policy applicable target application information and network usage control policy information for each of the policy applicable target applications—from the policy server 200 through the policy reception unit 120 (or network load reduction application), and may store the received policy information in a storage section 140 using a policy storage unit 130 (or network load reduction application) (S710).

Afterwards, the wireless terminal device 100, after checking if the network load reduction application is running, may run the network load reduction application (S715).

The step S715 may be omitted, or may be changed the order with the step S710.

Afterwards, the wireless terminal device 100 may check whether the policy information for reducing network load exists using the policy checking unit 150 (or network load reduction application) (S720).

If the policy information for reducing network load does not exist as a result of checking in the step S720, the wireless terminal device 100 may send a request for the policy information to the policy server 200, and may receive policy information for reducing network load—the policy information including at least one of policy applicable target application information and network usage control policy information for each application—from the policy server 200 through the policy reception unit 120 (or network load reduction application), and may store the policy information into a storage section 140 using the policy storage unit 130 (or network load reduction application) (S730).

In case the policy information for reducing network load exists as a result of checking in the step S720, the wireless terminal device 100 may check the policy applicable target application using the policy checking unit 150 (or network load reduction application) (S740).

When the policy applicable target application is checked in the step S740 (S745), the wireless terminal device 100 may check the network usage control policy information corresponding to the policy applicable target application stored in the storage section 140 using the process unit 160 (or network load reduction application) (S750).

In case the policy applicable target application is not checked in the step S740, the wireless terminal device 100 may repeat the step S740 (S755).

Afterwards, the wireless terminal device 100 may control network usage for the policy applicable target application by applying the policy corresponding to the network usage control policy checked in the step S750 using the process unit 160 (or network load reduction application) (S760).

Not shown in FIG. 7, the step S760, in case the network usage control policy information is policy information for adjusting number of connections to a certain IP or Port or URL per hour, may further include: counting number of connections to a certain IP or Port or URL of the policy applicable target application per hour; comparing the counted number with pre-set number of connections per hour in policy information; and in case the counted number corresponds with the pre-set number in the policy information as a result of the comparing, blocking connection to the certain IP or Port or URL of the policy applicable target application.

In addition, the step S760, in case the network usage control policy information is policy information for adjusting number of pollings to a certain IP, or Port, or URL, may further include: counting number of pollings to a certain IP or Port or URL of the policy applicable target application; comparing the counted number with pre-set number of pollings in the policy information; and in case the counted number corresponds with the pre-set number of pollings in the policy information, blocking data request to the certain IP or Port or URL of the policy applicable target application.

In addition, the step S760, in case the network usage control policy information is policy information for adjusting number of pushes transmitting data to a certain IP or Port or URL or ID, may further include: counting number of pushes transmitting data to a certain IP or Port or URL or ID for the policy applicable target application; comparing the counted number and pre-set number of pushes in the policy information; and in case the counted number corresponds with the pre-set number in the policy information as a result of the comparing, blocking data push to the certain IP or Port or URL of the policy applicable target application.

In addition, the step S760, in case the network usage control policy information is policy information for adjusting size or capacity of data transmitted to a certain IP or Port or URL or ID, may further include: checking size or capacity of data transmitted to a certain IP or Port or URL or ID for the policy applicable target application; and in case the size of data exceeds pre-set size or capacity in the policy information as a result of the checking, blocking data transmission to the certain IP or Port or URL of the policy applicable target application.

In addition, the step S760, in case the network usage control policy information is policy information for blocking request and reception of user unauthorized target data including commercial data, may further include: checking whether a certain IP or Port or URL, to which the policy applicable target application is connecting, is an address for request or reception of user authorized target data; and in case the certain IP or Port or URL, to which the policy applicable target application is connecting, is not an address for request or reception of user authorized target data as a result of the checking, blocking connection to the certain IP or Port or URL of the policy applicable target application.

In addition, the step S760, in case a limit allocated to the wireless terminal device 100 is exceeded, may further include: comparing the limit allocated to the wireless terminal device 100 with amount of data usage consumed up to a current time point; in case the limit allocated to the wireless terminal device 100 is exceeded as a result of the comparison, blocking data communication connection of the policy applicable target application.

In addition, the step S760, in case the network usage control policy information is policy information for blocking connection of data communication when a communication network overload is set in a region where the wireless terminal device 100 is located, may further include: counting delay time caused by the communication network overload in the region where the wireless terminal device 100 is located; comparing the counted value with a pre-set time in the policy information; and in case the counted value exceeds the pre-set time in the policy information as a result of the comparison, blocking data communication connection of the policy applicable target application.

In addition, the above-described present invention may be implemented as a program executable in a computer and may be stored in a computer-readable recording medium; examples of the computer-readable recording medium may be ROM, RAM, CD-ROM, Magnetic Tape, Floppy Disk, Optical Data Storage, etc., including carrier wave (e.g., transmission through internet).

The computer-readable recording medium may be distributed to a computer systems connected in a network, so that the computer-readable code may be stored and executed in a distributed mode. Also, functional program, code and code segments for implementing the controlling method may be inferred easily by programmers who skilled in the art of the present invention.

In the above, preferred embodiments of the present invention have been described. However, these embodiments are merely examples and do not limit the present invention, so that persons who skilled in the art of the present invention may easily transform and modify within the limit of the technical spirit of the present invention. For example, each of the components shown in detail in the embodiments of the present invention may be implemented in transformation. In addition, the differences relating these transformations and modifications shall be regarded to be included in the scope of the present invention as defined in the attached claims of the present invention.

1-19. (canceled)

20. A wireless terminal device having function for reducing network load, the wireless terminal device having one or more applications using a communication network, comprising:
a policy storage unit for storing policy information for reducing network load in a storage section, wherein the policy information is received from a server and includes at least one of information of network usage control policy and information of policy applicable target that the policy is applied to; and
a process unit for controlling network usage environment of the wireless terminal device by applying the network usage control policy information to the policy applicable target according to the policy information stored in the storage section.

21. The wireless terminal device having function for reducing network load according to claim 20, wherein the information of the policy applicable target includes at least one of information of one or more applications and information of one or more addresses accessed by the wireless terminal device.

22. The wireless terminal device having function for reducing network load according to claim 20, further comprising:
a policy checking unit for checking whether there exists the policy information stored in the storage section, and checking whether a policy applicable target application according to the policy information is included in the wireless terminal device in case there exists the policy information.

23. The wireless terminal device having function for reducing network load according to claim 22, wherein the process unit, in case the policy applicable target application is included in the wireless terminal device, controls the network usage environment of the policy applicable target application by applying the network usage control policy information to the policy applicable target application included in the wireless terminal device.

24. The wireless terminal device having function for reducing network load according to claim 22, wherein policy checking unit sends a request for the policy information to a server over the communication network in case there exists none of the policy information stored in the storage section.

25. The wireless terminal device having function for reducing network load according to claim 20, further comprising:
an upgrade unit for upgrading the policy information stored in the storage section periodically or whenever changes occur.

26. The wireless terminal device having function for reducing network load according to claim 20, wherein the policy information is information for controlling periodic access or data communication by an application in background.

27. The wireless terminal device having function for reducing network load according to claim 26, wherein the policy information is information for controlling keep-alive or polling signals periodically transmitted by the application in background.

28. The wireless terminal device having function for reducing network load according to claim 20, wherein the network usage control policy information includes information for adjusting at least one of number of connections, number of pollings requesting data, number of pushes transmitting data and size or capacity of data transmitted to a certain IP or URL.

29. The wireless terminal device having function for reducing network load according to claim 20, wherein the network usage control policy information includes information for blocking request and reception of unauthorized data including commercial data.

30. The wireless terminal device having function for reducing network load according to claim 20, wherein the network usage control policy information includes information for blocking connection of data communication in case a data communication limit allocated to the wireless terminal device is exceeded or a communication network overload occurs in a region where the wireless terminal device is located.

31. The wireless terminal device having function for reducing network load according to claim 20, wherein the network usage control policy information includes information of a type or an application time for the policy information.

32. The wireless terminal device having function for reducing network load according to claim 20, wherein the network usage environment includes at least one of number of network connections, network connection time, number of data transmissions, number of data receptions, data transmission capacity, data reception capacity, data transmission time, data reception time, IP or URL of a connection target network, IP or URL of a connection blocking target network, data communication limit and network loading amount.

33. A method for reducing network load in a wireless terminal device having one or more applications using a communication network, comprising:
receiving policy information for reducing network load from a server, wherein the policy information includes at least one of at least one of information of network usage control policy and information of policy applicable target that the policy is applied to;
storing the received policy information in a storage section; and
controlling network usage environment of the wireless terminal device by applying the network usage control policy information to the policy applicable target according to the policy information stored in the storage section.

34. The method for reducing network load according to claim 33, wherein the information of the policy applicable target includes at least one of information of one or more applications and information of one or more addresses accessed by the wireless terminal device.

35. The method for reducing network load according to claim 33, wherein the policy information is information for controlling keep-alive or polling signals periodically transmitted by an application in background.

36. The method for reducing network load according to claim 33, wherein the controlling comprises adjusting at least one of number of connections, number of pollings requesting data, number of pushes transmitting data and size or capacity of data transmitted to a certain IP or URL, by being compared with a pre-set reference value.

37. The method for reducing network load according to claim 33, wherein the controlling comprises blocking request and reception of unauthorized data including commercial data.

38. The method for reducing network load according to claim 33, wherein the controlling comprises blocking connection of data communication in case a data communication limit allocated to the wireless terminal device is exceeded or a communication network overload occurs in a region where the wireless terminal device is located.

39. A computer-readable recording medium for recording programs to execute the method of claims 33.
